(19) United States
(12) Patent Application Publication
(10) Pub. No.: US 2017/0127623 A1
(43) Pub. Date: May 11, 2017

(54) COMPOSITE LOAD BEARING MEMBER

(71) Applicant: SETEVOX (PTY) LTD, Pretoria (ZA)

(72) Inventor: Johann Adriaan Venter, Vereeniging (ZA)

(21) Appl. No.: 15/319,251

(22) PCT Filed: Jan. 18, 2015
(86) PCT No.: PCT/ZA2015/000044

§ 371 Date: Dec. 15, 2016

(30) Foreign Application Priority Data
Jun. 18, 2014 (ZA) 2014/04449

(51) Int. Cl. A01G 17/04

(52) U.S. Cl. CPC A01G 17/04

(57) ABSTRACT

The invention provides a composite load bearing member, such as a pole, which can be built for any specific design load with the objective of low cost to replace wood support applications for similar loads, typically up to 10 ton yield support load. The member has at least two layers but may also comprise of three layers for applications where UV protection and flame retardancy is paramount. The inside layer consists of a thermoplastic pipe of low cost, preferably HOPE, PET or PVC. The thermoplastic may or may not contain a flame retardant. The next layer consists of a thin fibreglass pipe as shell for the thermoplastic to enable strength. This fibreglass pipe will be tight fitting on the thermoplastic since the thermoplastic can be used as mandrel for the fibreglass pipe which can be manufactured by pultrusion or pullwinding or fibreglass fabric rolling. The fibreglass resin can be phenolic, epoxy, polyester or vinylester.

### FIELD OF THE INVENTION

The invention relates to poles for load bearing applications, in particular composite poles which are light weight. A typical application for such poles is in vineyards to support vines.

### BACKGROUND TO THE INVENTION

Presently load bearing poles are made of wood or concrete, for example, presently in vineyards a popular load bearing pole is made of wood with creosote coating to prolong its useful life.

Furthermore, the pole are preserved with Chromium Copper Arsenic solution prior to being coated with creosote which makes disposal thereof at its life end a problem as it cannot be reused for convention uses.

The inventors have thus provided a composite load bearing pole as disclosed herebelow to address, at least partially, the above shortcomings and to provide an alternative for those requiring a light weight load bearing pole.

### SUMMARY OF THE INVENTION

Thus, in accordance with the invention, there is provided a composite pole that can be custom built for any specific design load with the objective of low cost to replace wood support applications for similar loads, typically up to 10 ton yield support load.

The pole may have at least two layers but may have three or more layers for applications where UV protection and flame retardancy is paramount, wherein the inside layer consists of a thermoplastic pipe selected from HDPE, PET, and PVC, typically HDPE.

The thermoplastic may or may not contain a flame retardant.

The next layer consists of a thin fibreglass pipe as shell for the thermoplastic to provide strength, wherein this fibreglass pipe is tight fitting with the thermoplastic so that the thermoplastic may be used as a mandrel for the fibreglass pipe which may be manufactured by pultrusion or pullwinding or fibreglass fabric rolling.

The fibreglass resin may be phenolic, epoxy, polyester or vinylester, but typically phenolic resin for its flame resistant properties for outdoor, underground or construction applications.

The fibreglass resin may be a polyester resin which is typically used when a fire resistant gel coat is used on the outside of the fibreglass pipe.

The fibreglass fibre orientation inhibits buckling when it is compressed under load in its axial direction and is balanced for high bending strength to withstand bending moment forces.

Where there is a third layer on the outside of the fibreglass pipe, this layer is a painted or coated UV protective layer for extending the life of the pole in outdoor use.

The fibreglass resin itself may be filled with a UV stabilising filler. Typically most applications will be designed for loads between 50 kg and 20 tons for the composite pole whereby the wall thickness and diameter of the thermoplastic pipe and fibreglass are optimised for lowest cost for a specific application and design load.

A typical application for outdoor use of the composite pole is support of vineyards and replacement of the creosote wooden poles, typically for supporting loads between 1 ton and 15 tons.

A benefit of the invention is that the thermoplastic pipe can be separated and recycled or re-used to lower the effective overall lifecycle cost of the product. Benefits of this low cost composite pole includes: light weight, non-corrosive, maintenance free, longevity, non-conductive, high bending strength and vandal resistant.

According to a further aspect of the invention, there is provided a composite load bearing member, the composite member having at least an inner thermoplastic pipe and an outer fibreglass pipe with specific wall thickness ratios depending on the load strengths required.

The inner layer may consist of a thermoplastic material selected from HDPE, PET, and PVC. The inner layer may be made of HDPE. The thermoplastic may contain a flame retardant. The thermoplastic may contribute relatively little to the overall load carrying capacity in comparison to the outer layer, and is provided mainly for durability and to increase wall thickness.

HDPE may be the preferred thermoplastic because of its lower brittleness and more elastomeric nature that can withstand high impact e.g. when these supports need to be hit to penetrate the ground/soil. A further benefit is that it also serves as mandrel for the fibreglass outer pipe during the production process where the relative high melting point of HDPE makes it an ideal material.

The second layer consists of a thin fibreglass layer on the outside of the thermoplastic layer to provide strength.

The thermoplastic layer may be in the form of a pipe having a wall thickness of from 2 to 10 mm, typically from 3 to 7 mm, more typically from 4 to 6 mm.

The fibreglass layer may in the form of a pipe having a thickness of from 1 to 10 mm, typically from 2 to 7 mm, more typically from 2 to 5 mm.

This fibreglass pipe may be tight fitting onto the thermoplastic pipe since the thermoplastic is used as mandrel for the fibreglass pipe which is manufactured by pultrusion or pullwinding or fibreglass fabric rolling.

The fibreglass resin of the fibreglass layer may be selected from phenolic, epoxy, polyester or vinylester resin. Typically the fibreglass resin is phenolic resin for its flame resistant properties for outdoor applications or underground applications in mining.

A polyester resin may be used when a fire resistant gel coat is applied on the outside of the composite pipe.

The orientation of the fibre of the fibreglass may prevent buckling when it is compressed under load in its axial direction and is balanced for high bending strength to withstand bending moment forces. The fibreglass fibre orientation may vary between 1-49% radial and the balance of the fibre orientation being longitudinal for balancing between hoop strength and longitudinal tensile strength.

Typically, the lay-up is from 60% to 80% longitudinal fibres with the balance of the fibres being radial for hoop strength.

The load bearing member may have a third layer on the outside of the fibreglass layer which is a painted or coated UV protective layer for extending the useful life for outdoor use.

The fibreglass resin itself may be filled with a UV stabilising filler, if needed for a specific application.

A typical application for outdoor use of the composite pole is support of vineyards and replacement of the creosote wooden pole. In this application, the fibreglass is coated with a gel coat for UV protection with a uniform thickness between 250 micron and 500 micron, complying with SABS standard SANS141. The gel coat may provide a weatherproof, UV resistant, flame resistant and impact strong surface in the colour specified. The gel coat is typically a polyester or even an epoxy which may include e.g. hydrated alumina as flame retardant.

The wall thickness ratio of the thermoplastic layer and fibreglass layer may be optimised for lowest cost for a specific application. The wall thickness ratio of thermoplastic to fibreglass can vary between 0.7 and 3.0 going from 20 tons yield load down to 1.5 tons therefore there appears to be a measurable inverse relationship between wall thickness ratio and yield load.

The thermoplastic layer may be separated and recycled or re-used to lower the effective overall lifecycle cost of the product. Benefits of this low cost composite pole includes: light weight, non-corrosive, maintenance free, longevity, non-conductive, high bending strength and vandal resistant.

The design of the composite pole wall thickness and diameter can be changed to support any desired weight. Typically most applications will be designed for loads between 50 kg and 20 tons for the composite pole. Typical designs for optimising lowest cost can be seen in Table 1 below.

TABLE 1
Typical designs for optimising highest strength for lowest cost

| Yield | | HDPE | HDPE | Fibreglass | Fibreglass | Total |
|---|---|---|---|---|---|---|
| load | | ID (mm) | OD (mm) | ID (mm) | OD (mm) | weight (kg/m) |
| 1.5 | ton | 21 | 25 | 25 | 27 | 0.67 |
| 2.5 | ton | 28 | 32 | 32 | 34.5 | 1.03 |
| 3 | ton | 35 | 40 | 40 | 42.2 | 1.20 |
| 7.5 | ton | 71 | 75 | 75 | 78.4 | 3.09 |
| 10 | ton | 86 | 90 | 90 | 93.9 | 4.17 |
| 15 | ton | 84 | 90 | 90 | 96.7 | 7.14 |

A typical application for outdoor use of the composite pole is support of vineyards and replacement of the creosote wooden pole.

### DESCRIPTION OF EMBODIMENTS OF THE INVENTION

The invention will now be described, by way of non-limiting examples only, with reference to the accompanying representations.

### EXAMPLE 1

Composite pole designed for load of 2.5 tons for vineyard or farm fence support. The thermoplastic pipe (with or without flame retardant) has an inside diameter of 28 mm and outside diameter of 32 mm. The fibreglass shell on the outside of the thermoplastic pipe has an inside diameter of 32 mm and outside diameter of 34.5 mm (therefore a 2.5 mm wall thickness for supplying strength to the thermoplastic for balancing axial load and wind bend moment forces). For this application a phenolic resin will be preferred for flame resistance. A polyester resin can also be used for the fibreglass in the case where the outside gel coat has flame resistant properties. With these dimensions the composite pole will be able to support a load of 2.5 tons before yielding. The fibreglass is then coated with a gel coat in this example for UV protection with a uniform thickness between 250 micron and 500 micron (complying with SABS standard SANS141).

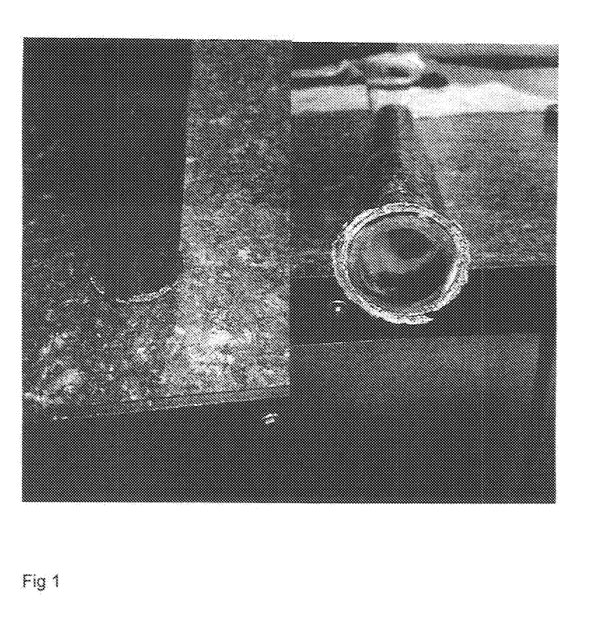

See FIG. 1 for actual photos after a yield test.

### Experiments

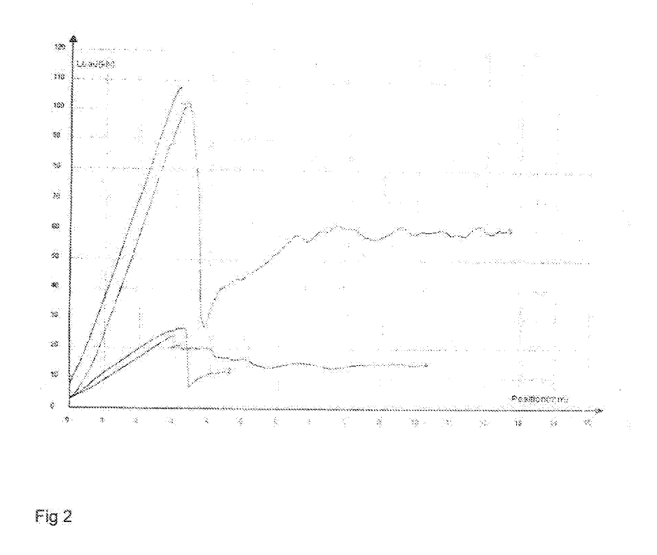

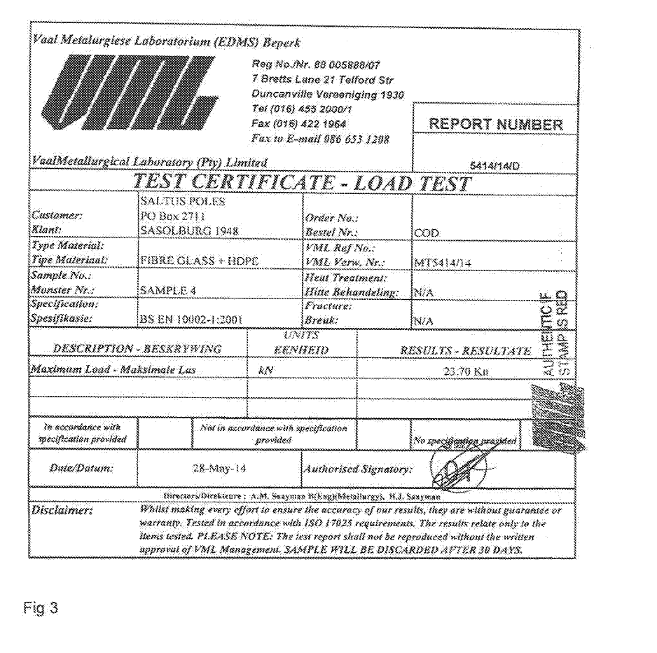

FIGS. 2 and 3 show axial load test results of composite poles described above.

The Tests were conducted on composite poles as follows:

Test 1: Fibreglass only with ID=26 mm and OD=34 mm. Not tapered at top.

Test 2: HDPE pipe with ID=26 mm and OD=32 mm, with Fibreglass shell with ID=32 mm and OD=34 mm. Fibreglass not tapered at top.

Test 3: Fibreglass only with ID=26 mm and OD=34 mm. Not tapered at top. Repeat of test 1.

Test 4: HDPE pipe with ID=26 mm and OD=32 mm, with Fibreglass shell with ID=32 mm and OD=34 mm. Fibreglass tapered at top to enable slow yielding mechanism.

It can also be noted that test no. 4 had a taper and test no. 2 had no taper. The effect of gradual deformation on test no. 4 is clearly visible.

In FIG. 2 there is seen the load deformation graphs for test no. 2 and test no. 4 which shows a yield load of 2.6 tons and 2.3 tons respectively

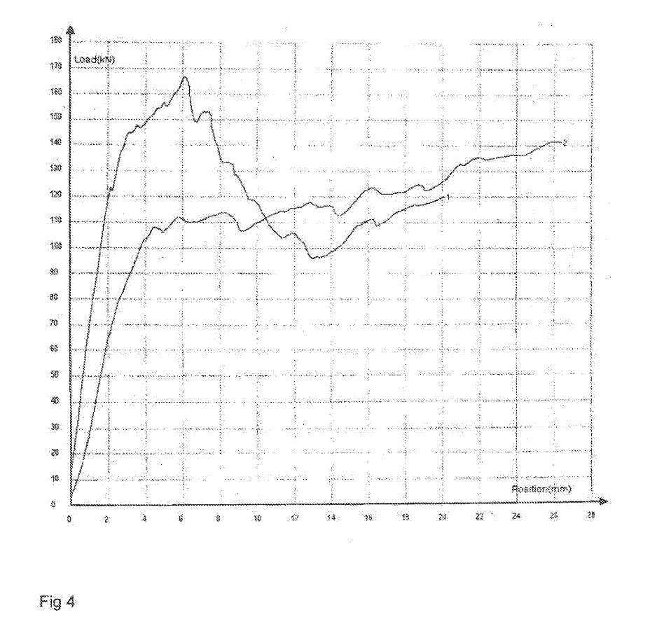

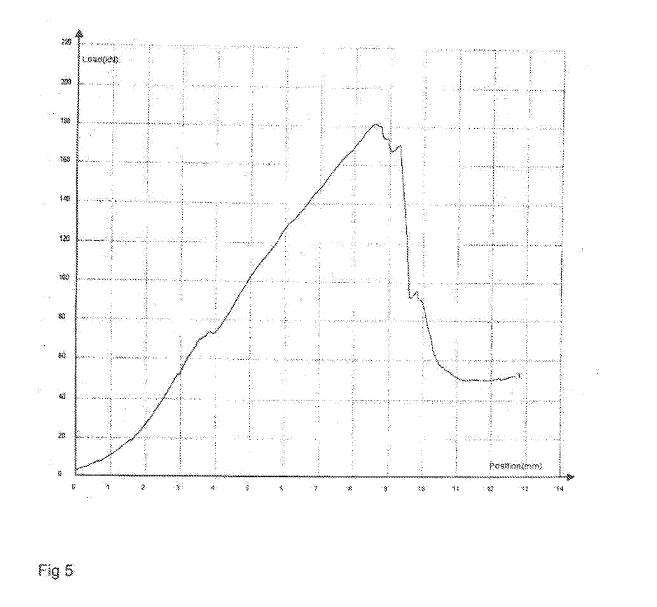

All tests shown in FIG. 2 were done with a longitudinal (tensile strength) fibre lay-up of 80% with the balance of 20% in the radial (hoop strength) direction. Further tests were done varying the tensile versus hoop strength for optimising the wall thickness of the fibreglass sleeve for lowest cost. FIGS. 4 and 5 show these test results.

FIG. 4 shows two test results from Table 2 below:

TABLE 2

| | | | | | Fibreglass |
|---|---|---|---|---|---|
| | HDPE | HDPE | Fibreglass | Fibreglass | fibre tensile |
| | ID (mm) | OD (mm) | ID (mm) | OD (mm) | to hoop ratio |
| Test 1 | 84 | 90 | 90 | 98 | 50:50 |
| Test 2 | 84 | 90 | 90 | 98 | 20:80 |

FIG. 5 show test results for the following tests in Table 3:

TABLE 3

| | | | | | Fibreglass |
|---|---|---|---|---|---|
| | HDPE | HDPE | Fibreglass | Fibreglass | fibre tensile |
| | ID (mm) | OD (mm) | ID (mm) | OD (mm) | to hoop ratio |
| Test 1 | 84 | 90 | 90 | 98 | 80:20 |

The test results show that the maximum yield load (18 tons) is achieved with a tensile to hoop ratio of 80:20. This ratio gives the optimum lowest cost for balancing tensile vs hoop strength. The hoop strength is necessary for handling buckling forces.

The only positive result from the low hoop strength test (FIG. 4, test 2, tensile vs hoop ratio of 20:80) was the fact that a slow yielding mechanism was enabled. But this yielding mechanism can also be obtained by tapering the fibreglass pole at the top (reference patent by same inventor ZA2012/05524). Lower hoop strength application might be considered for specific applications where major non-axial forces could be expected.

FIG. 4 shows the effect of varying fibreglass tensile vs hoop fibre ratio for the same ID and OD HDPE and fibreglass pole. Test 1 has tensile to hoop ratio of 50:50 and test 2 has tensile to hoop ratio of 20:80

FIG. 5 shows Tensile to hoop ratio of 80:20 for same ID and OD pole as shown in FIG. 4 This is optimal for the lowest cost with best balance between tensile and hoop strength.

Another design constraint for the fibreglass wall thickness and fibre tensile vs hoop ratio is wind load. The American Association of State Highways and Transportation Officials (AASHTO, 1985) standard for wind loads on signs and luminaires was used to indicate acceptable design tolerances for composite poles. According to this specification the wind load force for a 112 km/h wind will be 365 Pa for a lifetime exposure of 25 years. The maximum allowed deflection for an exposed pole length of 2 m is 200 mm on the tip (10% deflection allowed on length).

Table 4 below shows the results for deflection as calculated for a wind load force of 112 km/h (365 Pa). As can be seen from the table, all designs are within the specification of 10% deflection of total length above ground. The typical installation height shown is for vineyard support poles. As soon as the tensile to hoop ratio goes above 80:20 the ability of the pole to withstand side impact forces deteriorates and buckling can occur.

TABLE 4
Wind load deflection results for typical vineyard support applications.

| | | | | | | | | | Max | |
|---|---|---|---|---|---|---|---|---|---|---|
| | | | | | | | | | allowed | |
| | | | | | | Height | | | deflection | |
| Yield | | HDPE | HDPE | Fibreglass | Fibreglass | above | Wind | Deflection at | (10% of | Safety |
| load | | ID (mm) | OD (mm) | ID (mm) | OD (mm) | ground (m) | Force (N) | tip (mm) | length) | factor |
| 1.5 | ton | 21 | 25 | 25 | 27 | 2 | 19.7 | 91 | 200 | 2.2 |
| 2.5 | ton | 28 | 32 | 32 | 34.5 | 2 | 25.2 | 43 | 200 | 4.7 |
| 3 | ton | 35 | 40 | 40 | 42.2 | 2 | 30.8 | 32 | 200 | 6.3 |
| 7.5 | ton | 71 | 75 | 75 | 78.4 | 2 | 57.3 | 7 | 200 | 28.6 |
| 10 | ton | 86 | 90 | 90 | 93.9 | 2 | 68.6 | 4 | 200 | 50.0 |

1. A composite load bearing member having at least two layers:
(i) an inner thermoplastic layer; and
(ii) an outer fiberglass layer,
wherein the thermoplastic layer is in the form of a pipe having a wall thickness of from 2 to 10 mm, and further wherein the fiberglass layer is in the form of a pipe having a thickness of from 1 to 10 mm.

2. The composite member as claimed in claim 1 having a third UV-protective layer on the outside of the outer fiberglass layer, wherein a fiberglass fibre orientation in the outer fiberglass layer varies between 1-49% radial and the balance of the fibre orientation being longitudinal, and wherein a wall thickness ratio of the inner thermoplastic layer to the outer fiberglass layer is preferably larger than 1:1.

3. The composite member as claimed in claim 1 which is in the form of a pole.

4. The composite member as claimed in claim 1, wherein the inner thermoplastic layer is made of a material selected from HDPE, PET, and PVC.

5. The composite member as claimed in claim 1, wherein the resin of the outer fiberglass layer is selected from a phenolic, epoxy, polyester, and vinyl-ester resin.

6. (canceled)

7. (canceled)

8. The composite member as claimed in claim 1, wherein the wall thickness ratio of thermoplastic to fibreglass can vary between 0.7 and 3.0 going from 20 tons yield load down to 1.5 tons.

9. (canceled)

10. The composite member as claimed in claim 2, wherein the fiberglass fibre orientation in the outer fiberglass layer is 60-80% longitudinal and 20-40% radial.

11. (canceled)

12. The composite member as claimed in claim 2, wherein the third UV-protective layer includes a gel coat.

13. The composite member as claimed in claim 8, wherein the gel coat includes polyester or epoxy.

14. The composite member as claimed in claim 8, wherein the gel coat includes a flame retardant.

15. The composite member as claimed in claim 8, wherein the gel coat has a uniform thickness between 250-500 micron.

16. The composite member as claimed in claim 1, wherein the outer fiberglass layer comprises by itself of a UV-stabilizing filler.

17. The composite member as claimed in claim 1, which is a pole having a length of at least 1 meter.

18. The composite member as claimed in claim 1, wherein the outer fiberglass layer gets manufactured by pultrusion or pullwinding or fibreglass fabric rolling.

19. Use of the composite member as claimed in claim 1, as replacement for wood support members.
